(19) United States
(12) Patent Application Publication
(10) Pub. No.: US 2025/0338097 A1
(43) Pub. Date: Oct. 30, 2025

(54) IN-VEHICLE TERMINAL, BASE STATION, WIRELESS COMMUNICATION SYSTEM, AND RELAY STATION SELECTION METHOD

(71) Applicant: Mitsubishi Electric Corporation, Tokyo (JP)

(72) Inventors: Mari OCHIAI, Tokyo (JP); Shusaku UMEDA, Tokyo (JP); Yuji AKIYAMA, Tokyo (JP)

(73) Assignee: Mitsubishi Electric Corporation, Tokyo (JP)

(21) Appl. No.: 19/265,144

(22) Filed: Jul. 10, 2025

Related U.S. Application Data
(63) Continuation of application No. PCT/JP2023/003403, filed on Feb. 2, 2023.

(51) Int. Cl. H04W 4/46; H04W 24/04; H04W 48/20; H04W 64/00

(52) U.S. Cl. CPC H04W 4/46; H04W 24/04; H04W 48/20; H04W 64/00

(57) ABSTRACT

An in-vehicle terminal includes: a V2X communication control unit controlling communication with a neighboring vehicle capable of vehicle-to-vehicle communication; a neighboring vehicle information management unit managing neighboring vehicle information acquired by the vehicle-to-vehicle communication; a V2N communication control unit performing control to provide a first base station connected via direct communication with information on a second base station unable to be connected via direct communication and to request the first base station to provide connected terminal information on the neighboring vehicle connected to the second base station; a relay management unit selecting a relay station that is the neighboring vehicle relaying indirect communication with the second base station based on the neighboring vehicle information and the connected terminal information; and a redundant system management unit instructing the relay management unit to perform indirect communication with the second base station when the second base station cannot be connected via direct communication.

### CROSS-REFERENCE TO RELATED APPLICATION

This application is a continuation application of International Application PCT/JP2023/003403, filed on Feb. 2, 2023, and designating the U.S., the entire contents of which are incorporated herein by reference.

### BACKGROUND OF THE INVENTION

### 1. Field of the Invention

The present disclosure relates to an in-vehicle terminal to be installed on a vehicle, a base station, a wireless communication system, and a relay station selection method.

### 2. Description of the Related Art

In recent years, communication using a cellular network has been used for various applications. For example, in 3rd Generation Partnership Project (3GPP) (registered trademark) which is an international standard organization, multipath transmission has been studied in order to improve reliability of communication in a cellular network. The multipath transmission aims to improve the reliability of communication by transmitting the same information through a plurality of paths. A direct session between a base station and a terminal is basically employed for such a plurality of paths. However, a method has been studied in which in a case where direct sessions cannot be ensured at the same time, a plurality of sessions are ensured by using one direct session and one indirect session using sidelink communication.

In a case of improving the reliability of communication by a plurality of paths in a vehicle to be subjected to remote control, remote monitoring, or the like, a method for selecting a relay station for an indirect session is important. Many studies have been conducted so far on relay of communication from a moving terminal in vehicle-to-vehicle communication or the like, and many studies have also been conducted on a method for selecting a relay station. For example, Japanese Patent Application Laid-open No. 2009-212753 discloses, as a method for selecting a repeater in vehicle-to-vehicle communication, a technique in which a traveling direction, a traveling speed, and the like of a vehicle are obtained from position information of a neighboring vehicle and time of acquisition of the position information obtained by vehicle-to-vehicle communication, and a repeater is selected by using these pieces of information.

However, according to the above conventional technique, an in-vehicle communication device which is a communication source installed on a vehicle selects, as a repeater, an in-vehicle communication device highly likely to be capable of relaying communication to an in-vehicle communication device as a communication destination, from position information of neighboring vehicles and the like. Therefore, there may be a case where the in-vehicle communication device selected by the in-vehicle communication device as the communication source cannot actually communicate with the in-vehicle communication device as the communication destination, and cannot relay communication between the in-vehicle communication device as the communication source and the in-vehicle communication device as the communication destination, which is a problem.

### SUMMARY OF THE INVENTION

In order to solve the above-described problem, the present disclosure is an in-vehicle terminal that is installed on a vehicle and performs wireless communication with a plurality of base stations through a plurality of paths. The in-vehicle terminal the in-vehicle terminal comprises: a vehicle-to-vehicle communication control unit to control communication with a neighboring vehicle present around the vehicle and capable of vehicle-to-vehicle communication; a neighboring vehicle information management unit to manage neighboring vehicle information including position information of the neighboring vehicle and information on a communication state of the vehicle-to-vehicle communication, acquired by the vehicle-to-vehicle communication; a base station communication control unit to perform control to provide a first base station that is the base station connected via direct communication with information on a second base station that is the base station unable to be connected via direct communication and to request the first base station to provide connected terminal information that is information on the neighboring vehicle connected to the second base station; a relay management unit to hold the connected terminal information acquired from the first base station, and to select a relay station that is the neighboring vehicle that relays indirect communication with the second base station on a basis of the neighboring vehicle information and the connected terminal information; and a redundant system management unit to manage connection to the first base station and the second base station, and to instruct the relay management unit to perform indirect communication with the second base station when the second base station is unable to be connected via direct communication.

### BRIEF DESCRIPTION OF THE DRAWINGS

FIG. 1 is a diagram illustrating an exemplary configuration of a wireless communication system according to a first embodiment;

FIG. 2 is a block diagram illustrating an exemplary configuration of an in-vehicle terminal according to the first embodiment;

FIG. 3 is a diagram illustrating an example of neighboring vehicle information managed by a neighboring vehicle information management unit of the in-vehicle terminal according to the first embodiment;

FIG. 4 is a sequence diagram illustrating an operation in which a vehicle including the in-vehicle terminal according to the first embodiment installed thereon acquires connected terminal information of a base station 31 via a base station 30;

FIG. 5 is a block diagram illustrating an exemplary configuration of the base station according to the first embodiment;

FIG. 6 is a diagram illustrating an exemplary configuration of processing circuitry in a case where processing circuitry that realizes the in-vehicle terminal according to the first embodiment is realized by a processor and a memory;

FIG. 7 is a diagram illustrating an example of processing circuitry in a case where the processing circuitry that realizes the in-vehicle terminal according to the first embodiment is configured with dedicated hardware;

FIG. 8 is a block diagram illustrating an exemplary configuration of an in-vehicle terminal according to a second embodiment;

FIG. 9 is a block diagram illustrating an exemplary configuration of a base station according to the second embodiment;

FIG. 10 is a diagram illustrating an example of an operation in which the in-vehicle terminal installed on the vehicle selects a relay station in a wireless communication system according to the second embodiment;

FIG. 11 is a block diagram illustrating an exemplary configuration of a base station according to a third embodiment;

FIG. 12 is a sequence diagram illustrating an operation in which the vehicle including the in-vehicle terminal according to the third embodiment installed thereon acquires connected terminal information and relay station candidate information of a base station 31b via a base station 30b; and

FIG. 13 is a diagram illustrating an example of neighboring vehicle information managed by the neighboring vehicle information management unit of the in-vehicle terminal according to a fourth embodiment.

### DETAILED DESCRIPTION OF THE PREFERRED EMBODIMENTS

Hereinafter, an in-vehicle terminal, a base station, a wireless communication system, and a relay station selection method according to each embodiment of the present disclosure will be described in detail with reference to the drawings.

### First Embodiment

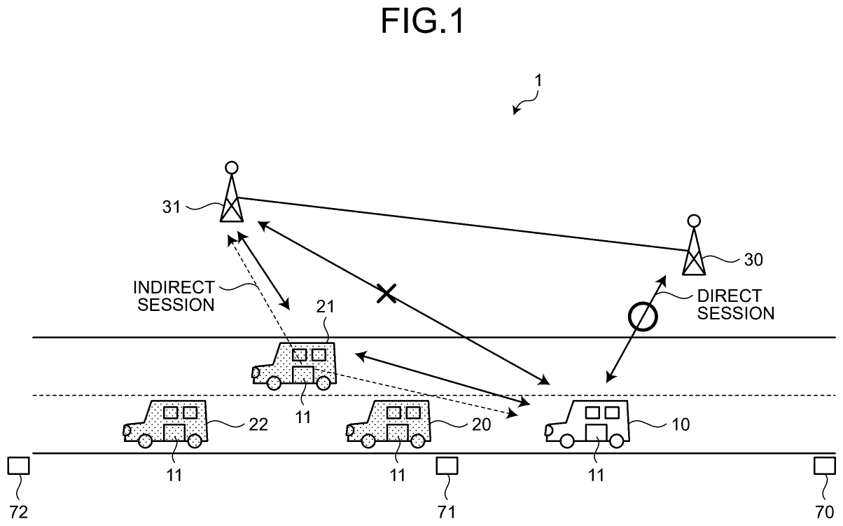

FIG. 1 is a diagram illustrating an exemplary configuration of a wireless communication system 1 according to a first embodiment. The wireless communication system 1 includes a vehicle 10, neighboring vehicles 20 to 22 present around the vehicle 10, base stations 30 and 31, and roadside devices 70 to 72. Regarding the wireless communication system 1 illustrated in FIG. 1, a case is assumed where the vehicle 10 performs wireless communication with the base stations 30 and 31 through a plurality of paths. The vehicle 10 does not need to use an indirect session when wireless communication with the base stations 30 and 31 can be performed and a plurality of direct sessions can be ensured, but uses an indirect session when a plurality of direct sessions cannot be ensured. As illustrated in FIG. 1, the vehicle 10 is in a situation in which a direct session has been established with the base station 30 but no direct session can be established with the base station 31. Therefore, in order to establish an indirect session with the base station 31, the vehicle 10 selects, from the neighboring vehicles 20 to 22, a relay station that relays communication between the vehicle 10 and the base station 31. Consequently, with one direct session and one indirect session, the vehicle 10 can ensure redundant lines and perform highly reliable communication.

In the following description, the neighboring vehicles 20 to 22 may be each simply referred to as a neighboring vehicle when not distinguished from each other, the base stations 30 and 31 may be each simply referred to as a base station when not distinguished from each other, and the roadside devices 70 to 72 may be each simply referred to as a roadside device when not distinguished from each other. In addition, in the following description, the direct session may be referred to as a direct connection, and the indirect session may be referred to as an indirect connection. In the example in FIG. 1, the wireless communication system 1 includes three neighboring vehicles, two base stations, and three roadside devices, but may include four or more neighboring vehicles, three or more base stations, and four or more roadside devices. Although FIG. 1 illustrates, as an example of the wireless communication system 1, only the neighboring vehicles 20 to 22 present ahead in the traveling direction of the vehicle 10, the vehicle 10 can also select a neighboring vehicle (not illustrated) present behind in the traveling direction of the vehicle 10 as a relay station in the indirect session with the base station 31. The vehicle 10 can also select a roadside device installed along a road on which the vehicle 10 travels as a relay station in the indirect session with the base station 31. The same applies to the following embodiments.

In the first embodiment, the vehicle 10 and the neighboring vehicles 20 to 22 each include an in-vehicle terminal 11. In the example in FIG. 1, the vehicle 10 and the neighboring vehicles 20 to 22 include the same type of in-vehicle terminals 11. However, as long as operations as described later can be performed, the in-vehicle terminals 11 installed on the vehicle 10 and the neighboring vehicles 20 to 22 may have partially different configurations, functions, and the like depending on manufacturers, vehicle types, and the like of the vehicle 10 and the neighboring vehicles 20 to 22. Hereinafter, a case will be described where the vehicle 10 and the neighboring vehicles 20 to 22 include in-vehicle terminals 11 of the same type, as illustrated in FIG. 1.

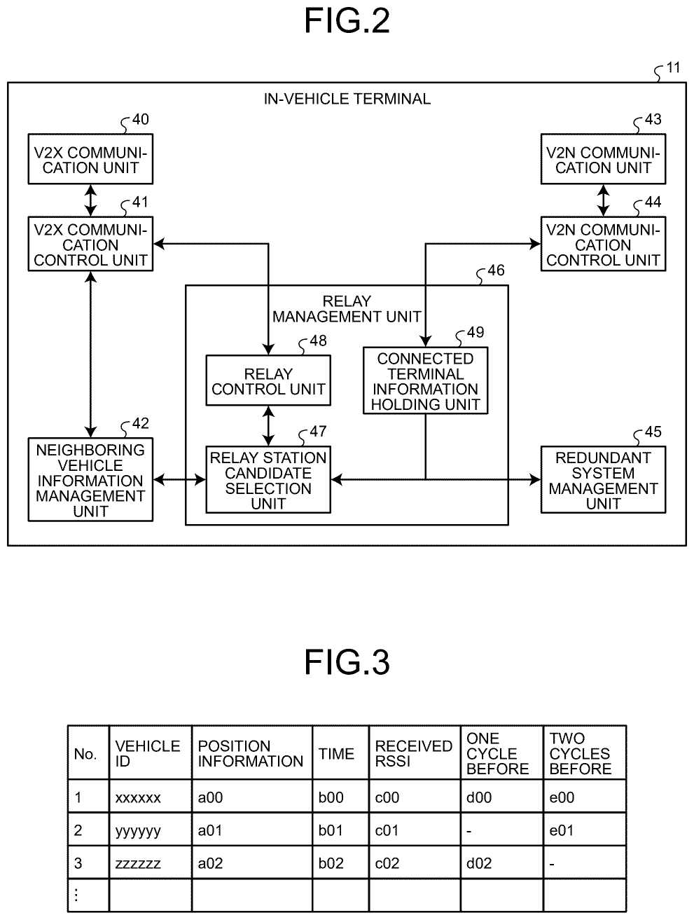

A configuration and operation of the in-vehicle terminal 11 will be described. FIG. 2 is a block diagram illustrating an exemplary configuration of the in-vehicle terminal 11 according to the first embodiment. The in-vehicle terminal 11 includes a vehicle to everything (V2X) communication unit 40, a V2X communication control unit 41, a neighboring vehicle information management unit 42, a vehicle to network (V2N) communication unit 43, a V2N communication control unit 44, a redundant system management unit 45, and a relay management unit 46. The relay management unit 46 includes a relay station candidate selection unit 47, a relay control unit 48, and a connected terminal information holding unit 49. Note that, the example in FIG. 2 does not depict a configuration related to general communication of V2X communication such as communication of basic safety message (BSM) which is not directly involved in a process for establishing an indirect session, a configuration related to general communication of V2N communication, and the like. Hereinafter, a description will be given for an operation of the in-vehicle terminal 11 that is installed on the vehicle 10 and performs wireless communication with a plurality of base stations through a plurality of paths.

The in-vehicle terminal 11 installed on the vehicle 10 exchanges, by the V2X communication unit 40 and the V2X communication control unit 41, BSMs and the like with the in-vehicle terminals 11 installed on the neighboring vehicles 20 to 22 via V2X communication, that is, vehicle-to-vehicle communication. As described above, the in-vehicle terminal 11 installed on the vehicle 10 actually performs the V2X communication with the in-vehicle terminals 11 installed on the neighboring vehicles 20 to 22. However, for simplicity of description, the above may be described hereinafter, for example, as follows: the vehicle 10 performs the V2X communication with the neighboring vehicles 20 to 22; or the in-vehicle terminal 11 performs the V2X communication with the neighboring vehicles 20 to 22.

The V2X communication unit 40 is a vehicle-to-vehicle communication unit that performs V2X communication with the neighboring vehicles 20 to 22 present around the vehicle 10 and capable of V2X communication.

The V2X communication control unit 41 is a vehicle-to-vehicle communication control unit that controls communication with the neighboring vehicles 20 to 22 present around the vehicle 10 and capable of V2X communication.

The neighboring vehicle information management unit 42 manages neighboring vehicle information including position information of neighboring vehicles and the like and information on a communication state of the V2X communication, each of which having been acquired by the V2X communication by the V2X communication unit 40 and the V2X communication control unit 41. That is, the neighboring vehicles managed as the neighboring vehicle information by the neighboring vehicle information management unit 42 include, in addition to the neighboring vehicles 20 to 22, the roadside devices 70 to 72 and the like as described above.

FIG. 3 is a diagram illustrating an example of the neighboring vehicle information managed by the neighboring vehicle information management unit 42 of the in-vehicle terminal 11 according to the first embodiment. The neighboring vehicle information management unit 42 manages the neighboring vehicle information in a table format as illustrated in FIG. 3. In FIG. 3, a vehicle identifier (ID) is identification information for identifying a neighboring vehicle. Position information is information indicating a current position of a neighboring vehicle. Time is information indicating a time when the neighboring vehicle information is acquired from a corresponding neighboring vehicle. Received received signal strength indicator (RSSI) is information on communication quality indicating a communication status of V2X communication with a neighboring vehicle with a corresponding vehicle ID, and here, indicates received signal strength as an example. One cycle before is information on communication quality indicating a previous communication status of V2X communication with a neighboring vehicle with a corresponding vehicle ID. Two cycles before is information on communication quality indicating a second previous communication status of V2X communication with a neighboring vehicle with a corresponding vehicle ID. The information on communication quality is not limited to the received RSSI, and an error rate, a signal to noise ratio (SNR), or the like may be used.

Note that the neighboring vehicle information illustrated in FIG. 3 is an example, and the neighboring vehicle information management unit 42 may also manage information such as a vehicle type and a traveling speed of each neighboring vehicle as the neighboring vehicle information as long as the information is obtained by V2X communication. In addition, the neighboring vehicle information management unit 42 may perform management such that a neighboring vehicle having more favorable communication status and more stable communication quality of V2X communication in the most recent prescribed period is placed closer to the top in the table. For example, the neighboring vehicle information management unit 42 performs management such that a neighboring vehicle having three previous received RSSIs which are the highest and stable is placed at the top. Here, “stable” means that, for example, a variation in the received RSSIs is the smallest and exceeds a prescribed threshold. In addition, the neighboring vehicle information management unit 42 may obtain a neighboring vehicle predicted to be traveling on the same road as the vehicle 10, a neighboring vehicle having a relative speed close to the vehicle 10, and the like from a transition in the latest position information, and manage the neighboring vehicle information in consideration of these elements.

The in-vehicle terminal 11 installed on the vehicle 10 performs wireless communication with the base station by the V2N communication unit 43 and the V2N communication control unit 44 in parallel with V2X communication. By establishing a plurality of sessions, the wireless communication between the in-vehicle terminal 11 installed on the vehicle 10 and the base station is used for communication of applications such as remote control and remote monitoring that require highly reliable communication. In addition, the wireless communication between the in-vehicle terminal 11 installed on the vehicle 10 and the base station is used for communication of services using a cellular network, for example, collection of position information and route information of the vehicle 10, and provision of congestion information and peripheral information by the base station. As described above, the in-vehicle terminal 11 installed on the vehicle 10 actually performs the wireless communication with the base station. However, for simplicity of description, the above may be described hereinafter, for example, as follows: the vehicle 10 performs the wireless communication with the base station.

The V2N communication unit 43 is a base station communication unit that performs wireless communication with a base station, i.e., in the example in FIG. 1, the base station 30 with which a direct session has been established.

The V2N communication control unit 44 is a base station communication control unit that controls wireless communication with a base station, i.e., in the example in FIG. 1, the base station 30 with which a direct session has been established. In addition, under the control of the redundant system management unit 45, the V2N communication control unit 44 performs control to provide the base station 30 connected via the direct session with information on the base station 31 that cannot be connected via the direct session and to request the base station 30 to provide connected terminal information which is information on neighboring vehicles connected to the base station 31. In the following description, the base station 30 may be referred to as a first base station, and the base station 31 may be referred to as a second base station.

The redundant system management unit 45 manages a plurality of sessions with the base stations. The redundant system management unit 45 manages a plurality of sessions so that the plurality of sessions can be established at all times, and in a case where a direct session cannot be established, the redundant system management unit 45 performs control such as switching to an indirect session or attempting the establishment by the direct session again. For example, in a case where the direct session cannot be established with the base station 31 as illustrated in FIG. 1, the redundant system management unit 45 instructs the relay management unit 46 to perform switching to the indirect session. At that time, the redundant system management unit 45 notifies, via the V2N communication control unit 44 and the V2N communication unit 43, the base station 30 of the fact that the direct session with the base station 31 cannot be established, that is, a failure in connection to the base station 31, and requests the connected terminal information which is information on the neighboring vehicles connected to the base station 31. Note that, in a case where the base station 30 is to make a request to the base station 31 for the connected terminal information when notified of the failure in connection to the base station 31 from the vehicle 10, the redundant system management unit 45 only needs to notify the base station 30 of the failure in connection to the base station 31. The connected terminal information which is information on the neighboring vehicles connected to the base station 31 is identification information of neighboring vehicles, roadside devices, and the like connected to the base station 31, and may include position information of the neighboring vehicles, the roadside devices, and the like connected to the base station 31. The identification information is, for example, a vehicle ID, but other information may be used as long as the information can identify the neighboring vehicles, the roadside devices, and the like. As described above, the redundant system management unit 45 manages the connection to the base station 30 and the base station 31, and instructs the relay management unit 46 to perform the indirect session with the base station 31 when the base station 31 cannot be connected via the direct session.

When the redundant system management unit 45 instructs the relay management unit 46 to perform switching to the indirect session, the connected terminal information holding unit 49 acquires the connected terminal information which is information on the neighboring vehicles connected to the base station 31 from the base station 30 via the V2N communication unit 43 and the V2N communication control unit 44 and holds the connected terminal information.

The relay station candidate selection unit 47 acquires the neighboring vehicle information from the neighboring vehicle information management unit 42, acquires the connected terminal information from the connected terminal information holding unit 49, and selects a candidate for a relay station to be used for the indirect session with the base station 31 on the basis of the neighboring vehicle information and the connected terminal information. In a case of selecting the candidate for the relay station, for example, the relay station candidate selection unit 47 selects a neighboring vehicle placed at the top from the neighboring vehicle information illustrated in FIG. 3, and in a case where the selected neighboring vehicle is included also in the connected terminal information acquired from the connected terminal information holding unit 49, the selected neighboring vehicle is set as the candidate for the relay station. The relay station candidate selection unit 47 indicates the selected candidate for the relay station to the relay control unit 48.

The relay control unit 48 instructs the V2X communication control unit 41 to start communication of a relay request to the neighboring vehicle which is the candidate for the relay station selected by the relay station candidate selection unit 47.

The V2X communication control unit 41 makes a relay request to the neighboring vehicle as the candidate for the relay station indicated by the relay control unit 48 via the V2X communication unit 40, and when the relay request is established, the V2X communication control unit 41 establishes the indirect session with the base station 31 using, as the relay station, the neighboring vehicle to which the relay request has been made, and starts wireless communication with the base station 31. When the relay request is not established, the V2X communication control unit 41 notifies the relay control unit 48 that the relay request has not been established. The relay control unit 48 notifies the relay station candidate selection unit 47 that the relay request has not been established. The relay station candidate selection unit 47 selects a candidate for a next relay station to be used for the indirect session with the base station 31 on the basis of the neighboring vehicle information and the connected terminal information. The in-vehicle terminal 11 repeats the above operation until the indirect session with the base station 31 is established. As described above, in the in-vehicle terminal 11, the relay management unit 46 holds the connected terminal information which is information on the neighboring vehicles connected to the base station 31 acquired from the base station 30, and selects a relay station which is a neighboring vehicle that relays the indirect session with the base station 31 on the basis of the neighboring vehicle information and the connected terminal information.

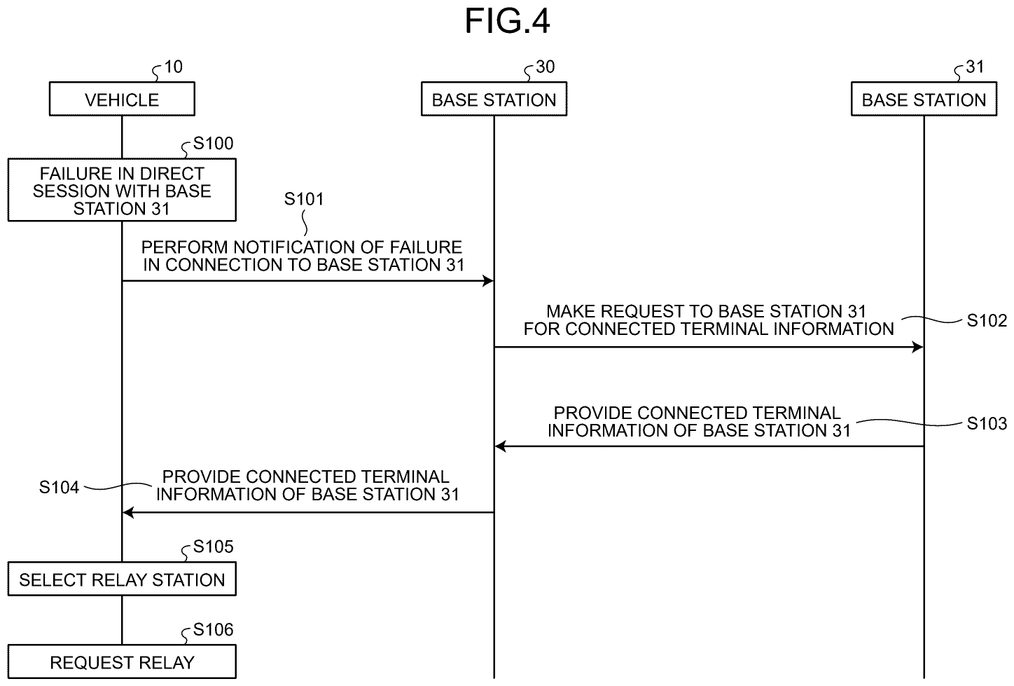

FIG. 4 is a sequence diagram illustrating an operation in which the vehicle 10 including the in-vehicle terminal 11 according to the first embodiment installed thereon acquires the connected terminal information of the base station 31 via the base station 30. When the direct session with the base station 31 fails (step S100), the vehicle 10 notifies the base station 30 of the failure in connection to the base station 31 (step S101). Here, assuming that the base station 30 is to make a request to the base station 31 for the connected terminal information when notified of the failure in connection to the base station 31 from the vehicle 10 as described above, the vehicle 10 notifies the base station 30 of the failure in connection to the base station 31 only. When notified of the failure in connection to the base station 31 from the vehicle 10, the base station 30 makes a request to the base station 31 for the connected terminal information which is information on the neighboring vehicles connected to the base station 31 (step S102). The base station 31 provides the base station 30 with the connected terminal information which is information on the neighboring vehicles connected to the base station 31 (step S103). When the connected terminal information which is information on the neighboring vehicles connected to the base station 31 is provided from the base station 31, the base station 30 provides the vehicle 10 with the connected terminal information which is information on the neighboring vehicles connected to the base station 31 (step S104). When acquiring, from the base station 30, the connected terminal information which is information on the neighboring vehicles connected to the base station 31, the vehicle 10 selects a candidate for a relay station to be used for the indirect session with the base station 31 on the basis of the neighboring vehicle information and the connected terminal information (step S105), and requests the selected relay station to relay to the base station 31 in the indirect session (step S106).

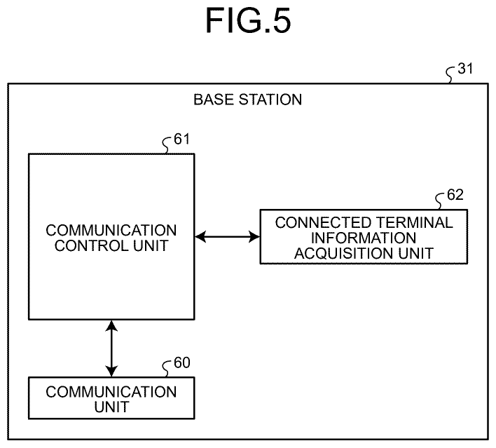

Next, a configuration and operation of the base stations 30 and 31 will be described. The base stations 30 and 31 are base stations in the wireless communication system 1 in which the vehicle 10 including the in-vehicle terminal 11 installed thereon performs wireless communication with the plurality of base stations 30 and 31 through a plurality of paths. Note that, the base stations 30 and 31 have similar configurations, and thus the base station 31 will be described here as an example. FIG. 5 is a block diagram illustrating an exemplary configuration of the base station 31 according to the first embodiment. The base station 31 includes a communication unit 60, a communication control unit 61, and a connected terminal information acquisition unit 62.

The communication unit 60 performs wireless communication with the neighboring vehicles 20 to 22. In addition, the communication unit 60 communicates with the base station 30 which is another base station. Communication between the base station 31 and the base station 30 may be wired communication or wireless communication. Here, the communication unit 60 performs wireless communication with the neighboring vehicles 20 to 22 and communication with the base station 30. However, the base station 31 may include two communication units, one communication unit may perform wireless communication with the neighboring vehicles 20 to 22, and the other communication unit may perform communication with the base station 30.

The communication control unit 61 controls wireless communication with the neighboring vehicles 20 to 22 and communication with the base station 30 as another base station, and performs control to provide the base station 30 as another base station with the connected terminal information in a case where there is a request from the base station 30 as another base station.

The connected terminal information acquisition unit 62 acquires identification information of the neighboring vehicles 20 to 22 with which wireless communication is performed and holds the identification information as the connected terminal information.

That is, in the case of the base station 31, the connected terminal information acquisition unit 62 holds connected terminal information which is information on the neighboring vehicles 20 to 22 connected to the base station 31, and the communication control unit 61 performs control to provide the base station 30 with the connected terminal information in a case where there is a request from the base station 30. In the case of the base station 30, the connected terminal information acquisition unit 62 holds connected terminal information which is information on the vehicle 10 connected to the base station 30, and the communication control unit 61 performs control to provide the base station 31 with the connected terminal information in a case where there is a request from the base station 31.

For example, in a case where the wireless communication system 1 is realized with the 3GPP specification, the neighboring vehicle information management unit 42 of the in-vehicle terminal 11 collects, for example, by vehicle-to-vehicle communication or vehicle-to-infrastructure communication via PC5, parameters of a neighboring vehicle with the 3GPP specification, that is, the in-vehicle terminal 11 as neighboring vehicle information. The connected terminal information acquisition unit 62 of the base station is installed in an external application server (application function (AF)) and manages connected terminal information. It is also possible for the base station to accept, in the direct session, a request from the in-vehicle terminal 11 for establishing an indirect session to another base station, and to start a process of the indirect session with the request from the in-vehicle terminal 11 as a trigger. From here, the in-vehicle terminal 11 uses, instead of monitoring, results of communication performed so far via a PC5 interface, and acquires, from the connected base station, connected terminal information which is a list of the in-vehicle terminals 11 connected to the desired base station. The connected terminal information expresses each in-vehicle terminal 11 by, for example, a relay station number. The in-vehicle terminal 11 selects a relay station by using the neighboring vehicle information managed by the neighboring vehicle information management unit 42 and the connected terminal information acquired from the connected base station.

Next, a hardware configuration of the in-vehicle terminal 11 will be described. In the in-vehicle terminal 11, the V2X communication unit 40 and the V2N communication unit 43 are communication devices. The V2X communication control unit 41, the neighboring vehicle information management unit 42, the V2N communication control unit 44, the redundant system management unit 45, and the relay management unit 46 are realized by processing circuitry. The processing circuitry may be a processor that executes a program stored in a memory and the memory, or may be dedicated hardware. The processing circuitry is also referred to as a control circuit.

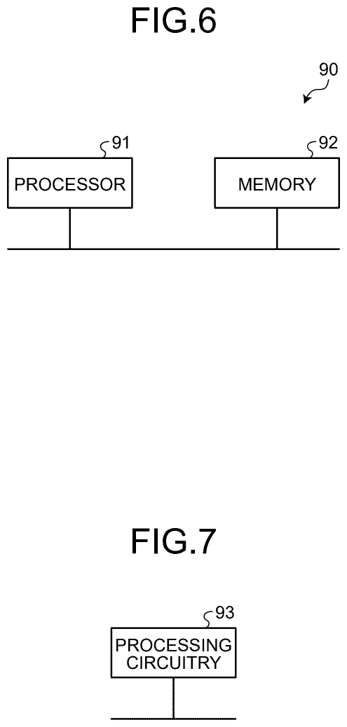

FIG. 6 is a diagram illustrating an exemplary configuration of processing circuitry 90 in a case where processing circuitry that realizes the in-vehicle terminal 11 according to the first embodiment is realized by a processor 91 and a memory 92. The processing circuitry 90 illustrated in FIG. 6 is a control circuit, and includes the processor 91 and the memory 92. In a case where the processing circuitry 90 is constituted with the processor 91 and the memory 92, functions of the processing circuitry 90 are realized by software, firmware, or a combination of software and firmware. The software or the firmware is described as a program and stored in the memory 92. In the processing circuitry 90, the processor 91 reads and executes the program stored in the memory 92, thereby realizing the functions. That is, the processing circuitry 90 includes the memory 92 for storing a program with which a process of the in-vehicle terminal 11 is executed as a result. It can also be said that this program is a program for causing the in-vehicle terminal 11 to execute the functions realized by the processing circuitry 90. This program may be provided by a storage medium having the program stored therein, or may be provided by other means such as a communication medium.

It can also be said that the above program is a program that causes the in-vehicle terminal 11 to execute: a first step performed by the V2X communication control unit 41 of controlling communication with the neighboring vehicles 20 to 22 present around the vehicle 10 and capable of vehicle-to-vehicle communication; a second step performed by the neighboring vehicle information management unit 42 of managing the neighboring vehicle information including the position information of the neighboring vehicles 20 to 22 and the information on the communication state of the V2X communication, each of which having been acquired by the V2X communication; a third step performed by the V2N communication control unit 44 of performing control to provide a first base station which is the base station 30 connected via direct communication with information on a second base station which is the base station 31 that cannot be connected via direct communication and to request the first base station to provide connected terminal information which is information on the neighboring vehicles connected to the second base station; a fourth step performed by the relay management unit 46 of holding the connected terminal information acquired from the first base station, and selecting a relay station which is a neighboring vehicle that relays indirect communication with the second base station on the basis of the neighboring vehicle information and the connected terminal information; and a fifth step performed by the redundant system management unit 45 of managing connection to the first base station and the second base station, and instructing the relay management unit 46 to perform indirect communication with the second base station when the second base station cannot be connected via direct communication.

Here, the processor 91 is, for example, a central processing unit (CPU), a processing device, an arithmetic device, a microprocessor, a microcomputer, or a digital signal processor (DSP). The memory 92 corresponds to, for example, a non-volatile or volatile semiconductor memory such as a random access memory (RAN), a read only memory (ROM), a flash memory, an erasable programmable ROM (EPROM), or an electrically EPROM (EEPROM (registered trademark)), a magnetic disk, a flexible disk, an optical disk, a compact disc, a mini disk, or a digital versatile disc (DVD).

FIG. 7 is a diagram illustrating an example of processing circuitry 93 in a case where the processing circuitry that realizes the in-vehicle terminal 11 according to the first embodiment is configured with dedicated hardware. The processing circuitry 93 illustrated in FIG. 7 corresponds to, for example, a single circuit, a composite circuit, a programmed processor, a parallel programmed processor, an application specific integrated circuit (ASIC), a field programmable gate array (FPGA), or a combination thereof. A part of the processing circuitry may be realized by dedicated hardware and another part thereof may be realized by software or firmware. Thus, the processing circuitry can realize each of the above-described functions by dedicated hardware, software, firmware, or a combination thereof.

The hardware configuration of the in-vehicle terminal 11 has been described. A hardware configuration of the base station is similar thereto. In the base station, the communication unit 60 is a communication device. The communication control unit 61 and the connected terminal information acquisition unit 62 are realized by processing circuitry. The processing circuitry may be a processor that executes a program stored in a memory and the memory, or may be dedicated hardware.

As described above, according to the present embodiment, in a case of selecting a relay station to be used for establishing the indirect session, the in-vehicle terminal 11 installed on the vehicle 10 acquires the connected terminal information which is information on the neighboring vehicles connected to the base station to which connection is desired, via the base station with which the direct session is established, and selects the relay station by using the connected terminal information. Consequently, the in-vehicle terminal 11 can improve the accuracy of selecting another in-vehicle terminal, that is, neighboring vehicle, capable of relaying communication with the base station. Since the in-vehicle terminal 11 no longer needs V2X communication for searching for the candidate for the relay station, it is possible to shorten a time until the indirect session is established.

Note that, in the first embodiment, the case has been described where the vehicle 10 that performs multipath communication establishes the indirect session with the base station 31, but the neighboring vehicles 20 to 22 can also perform multipath communication similarly. For example, the neighboring vehicle 21 illustrated in FIG. 1 has established a direct session with the base station 31, and thus can perform multipath communication by establishing an indirect session with the base station 30 by using the vehicle 10 as a relay station. In that case, the neighboring vehicle 21 performs, with the base station 31, an operation similar to the operation performed between the vehicle 10 and the base station 30 described above.

### Second Embodiment

In the first embodiment, the in-vehicle terminal 11 selects the relay station by using the neighboring vehicle information which is a result of the V2X communication, and the connected terminal information which is information on the neighboring vehicles connected to the base station as a target of the indirect session obtained via the base station connected in the direct session. In a second embodiment, a description will be given for a method in which an in-vehicle terminal selects a relay station to achieve more stable communication by further using position information of neighboring vehicles connected to a base station as a target of an indirect session obtained via a base station connected in a direct session.

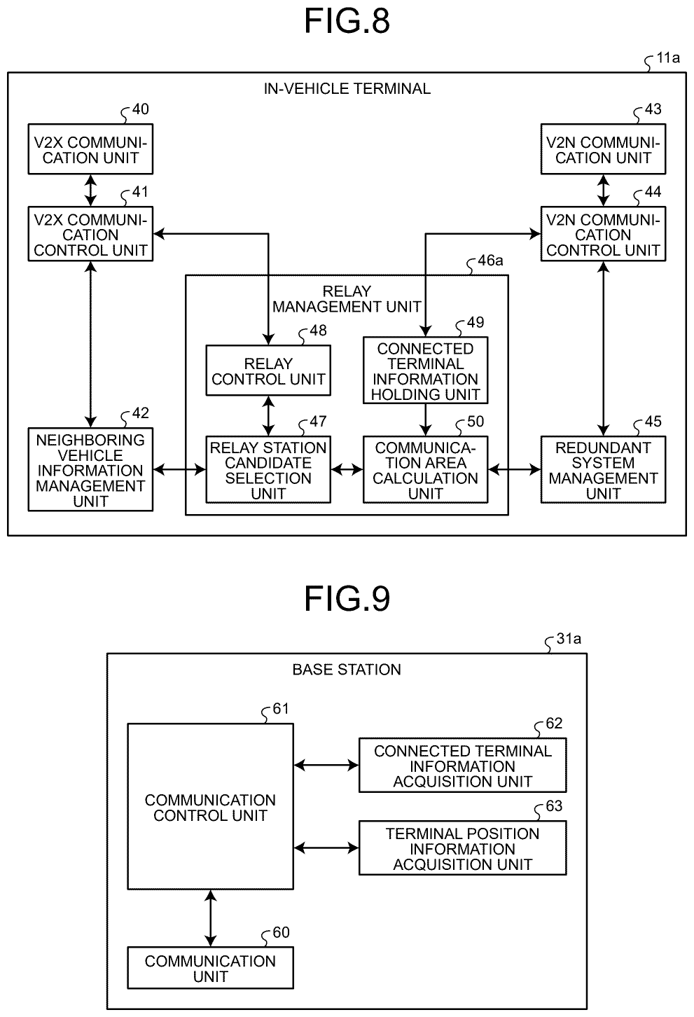

FIG. 8 is a block diagram illustrating an exemplary configuration of an in-vehicle terminal 11a according to the second embodiment. The in-vehicle terminal 11a is obtained by replacing the relay management unit 46 in the in-vehicle terminal 11 of the first embodiment illustrated in FIG. 2 with a relay management unit 46a. The relay management unit 46a is obtained by adding a communication area calculation unit 50 to the relay management unit 46 of the first embodiment illustrated in FIG. 2. In the second embodiment, connected terminal information acquired by the in-vehicle terminal 11a from a base station 30a to be described later includes position information on neighboring vehicles connected to a base station 31a to be described later, in addition to the information described in the first embodiment.

The connected terminal information holding unit 49 acquires connected terminal information that is information on the neighboring vehicles connected to the base station 31a and includes position information of the neighboring vehicles from the base station 30a via the V2N communication unit 43 and the V2N communication control unit 44 and holds the connected terminal information.

The communication area calculation unit 50 acquires the connected terminal information from the connected terminal information holding unit 49, and estimates a communication area of the base station 31a from the position information of the neighboring vehicles connected to the base station 31a included in the connected terminal information.

The relay station candidate selection unit 47 acquires the neighboring vehicle information from the neighboring vehicle information management unit 42, acquires the connected terminal information and the communication area calculated by the communication area calculation unit 50 from the communication area calculation unit 50, and selects a candidate for a relay station to be used for an indirect session with the base station 31a on the basis of the neighboring vehicle information, the connected terminal information, and the communication area.

Note that the operation of the relay control unit 48 is similar to the operation thereof in the first embodiment. As described above, in the second embodiment, the relay management unit 46a calculates the communication area of the base station 31a on the basis of the connected terminal information, and selects the relay station by further using the communication area of the base station 31a.

Next, a configuration and operation of the base stations 30a and 31a will be described. Note that, the base stations 30a and 31a have similar configurations, and thus the base station 31a will be described here as an example. FIG. 9 is a block diagram illustrating an exemplary configuration of the base station 31a according to the second embodiment. The base station 31a is obtained by adding a terminal position information acquisition unit 63 to the base station 31 of the first embodiment illustrated in FIG. 5.

The terminal position information acquisition unit 63 acquires and holds position information of neighboring vehicles with which the base station 31a is performing wireless communication.

In a case where there is a request from the base station 30a as another base station, the communication control unit 61 performs control to include the position information of neighboring vehicles in the connected terminal information and provide the base station 30a as another base station with the connected terminal information.

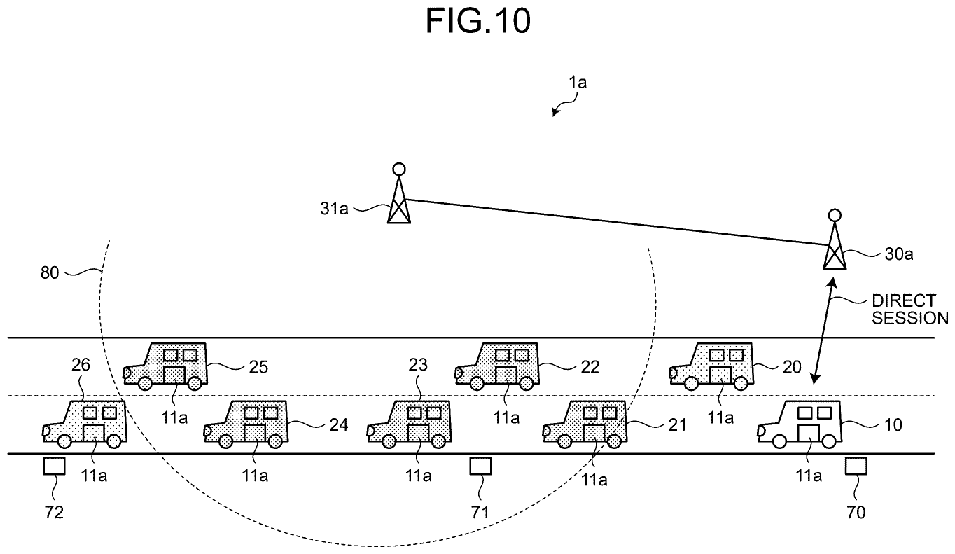

FIG. 10 is a diagram illustrating an example of an operation in which the in-vehicle terminal 11a installed on the vehicle 10 selects a relay station in a wireless communication system 1a according to the second embodiment. In FIG. 10, it is assumed that the vehicle 10 can communicate with neighboring vehicles 20 to 26 by V2X, and the neighboring vehicles 21 to 25 are connected to the base station 31a. The communication area calculation unit 50 of the in-vehicle terminal 11a installed on the vehicle 10 calculates an approximate communication area 80 of the base station 31a on the basis of the position information of the neighboring vehicles 21 to 25 connected to the base station 31a acquired via the base station 30a. The communication area 80 of the base station 31a calculated by the communication area calculation unit 50 is a range inside the dotted line illustrated in FIG. 10.

When the relay station candidate selection unit 47 of the in-vehicle terminal 11a installed on the vehicle 10 selects, for example, the neighboring vehicle 25 as a relay station, there is a possibility that the neighboring vehicle 25 immediately leaves the communication area 80 and the neighboring vehicle 25 performs handover from the base station 31a to another base station (not illustrated). After the handover from the base station 31a to another base station, the neighboring vehicle 25 cannot relay the indirect session between the vehicle 10 and the base station 31a. Therefore, the relay station candidate selection unit 47 selects, as a relay station, a neighboring vehicle that is expected to be in the communication area 80 of the base station 31a until the vehicle 10 enters the communication area 80 and has a good V2X communication status, for example, the neighboring vehicle 22.

By selecting the relay station as described above, the relay station candidate selection unit 47 can avoid a situation in which a neighboring vehicle serving as a relay station leaves the communication area 80 of the base station 31a in a short time and thus it is necessary to search for a neighboring vehicle serving as a relay station again.

In addition, since the relay station candidate selection unit 47 knows the position information of the neighboring vehicles 21 to 25 connected to the base station 31a, it is possible to estimate the traveling directions of the neighboring vehicles 21 to 25, the traveling speeds of the neighboring vehicles 21 to 25, whether the neighboring vehicles 21 to 25 are traveling on the same road as the vehicle 10, and the like from a transition in the position information of the neighboring vehicles 21 to 25. Therefore, the relay station candidate selection unit 47 may select the relay station in consideration of the estimated information regarding the traveling directions of the neighboring vehicles 21 to 25, the traveling speeds of the neighboring vehicles 21 to 25, whether the neighboring vehicles 21 to 25 are traveling on the same road as the vehicle 10, and the like. For example, the relay station candidate selection unit 47 can estimate a relayable time which is a time until a neighboring vehicle leaves the communication area 80 of the base station 31a, and can select the relay station by further using the relayable time.

Note that the communication area 80 of the base station 31a calculated by the communication area calculation unit 50 can be used not only for selection of the relay station by the relay station candidate selection unit 47 but also for determination as to whether the vehicle 10 has entered the communication area 80 of the base station 31a. In general, the vehicle 10 measures the position of the vehicle 10 by using a global positioning system (GPS) (not illustrated) or the like. Therefore, when the vehicle 10 reaches the communication area 80 of the base station 31a, the redundant system management unit 45 of the in-vehicle terminal 11a can control the V2N communication control unit 44 to attempt a direct session with the base station 31a.

Next, a hardware configuration of the in-vehicle terminal 11a will be described. In the in-vehicle terminal 11a, the relay management unit 46a is realized by processing circuitry. The processing circuitry may be a processor that executes a program stored in a memory and the memory, or may be dedicated hardware. The same applies to a hardware configuration of the base station. In the base station, the terminal position information acquisition unit 63 is realized by processing circuitry. The processing circuitry may be a processor that executes a program stored in a memory and the memory, or may be dedicated hardware.

As described above, according to the present embodiment, in a case of selecting a relay station to be used for establishing the indirect session, the in-vehicle terminal 11a installed on the vehicle 10 acquires the connected terminal information including the position information of the neighboring vehicles connected to the base station to which connection is desired, via the base station with which the direct session is established, and selects the relay station by using the connected terminal information including the position information. Consequently, in addition to the effects described in the first embodiment, the in-vehicle terminal 11a can avoid a situation in which the connected neighboring vehicle serving as a relay station immediately performs handover, and thereby stable communication can be performed, that is, it is possible to select a more efficient and appropriate relay station to establish a stable indirect session.

In the second embodiment, as an example, the case has been described where the position information of the neighboring vehicles obtained by the terminal position information acquisition unit 63 is included in the connected terminal information obtained by the connected terminal information acquisition unit 62, but there is no limitation thereto. The base station may separately handle the position information of the neighboring vehicles obtained by the terminal position information acquisition unit 63 and the connected terminal information obtained by the connected terminal information acquisition unit 62, and provide another base station with the pieces of information as separate information.

### Third Embodiment

In each of the first and second embodiments, the in-vehicle terminal selects the relay station. In a third embodiment, a case will be described where some functions of selecting a relay station are implemented by a base station. The third embodiment can be applied to the first embodiment and the second embodiment, but a description will be given below for a case where the third embodiment is applied to the second embodiment, as an example.

In the third embodiment, a configuration of the in-vehicle terminal 11a is similar to the configuration of the in-vehicle terminal 11a of the second embodiment illustrated in FIG. 8. In the third embodiment, although not illustrated, a base station that has established a direct session with the vehicle 10 is referred to as a base station 30b, and a base station that has not established a direct session with the vehicle 10 and is a target of an indirect session to be attempted by the vehicle 10 is referred to as a base station 31b.

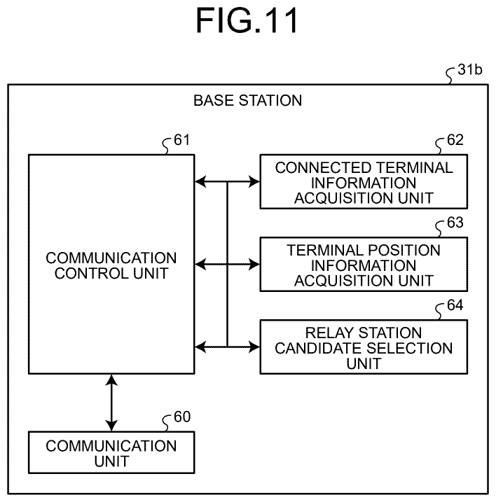

A configuration and operation of the base stations 30b and 31b will be described. Note that, the base stations 30b and 31b have similar configurations, and thus the base station 31b will be described here as an example. FIG. 11 is a block diagram illustrating an exemplary configuration of the base station 31b according to the third embodiment. The base station 31b is obtained by adding a relay station candidate selection unit 64 to the base station 31a of the second embodiment illustrated in FIG. 9.

On the basis of the connected terminal information including the position information of the neighboring vehicles 21 to 25, the relay station candidate selection unit 64 selects a vehicle to be a candidate for a relay station to be used by the vehicle 10 at the time of indirect communication with the base station 31b, the vehicle 10 being directly connected to the base station 30b as another base station by wireless communication. The relay station candidate selection unit 64 can obtain the connected terminal information including the position information by combining pieces of information acquired from the connected terminal information acquisition unit 62 and the terminal position information acquisition unit 63. The relay station candidate selection unit 64 can know where the neighboring vehicles 21 to 25 are present in the communication area 80 from the connected terminal information including the position information. Regarding a neighboring vehicle present at a position close to an edge of the communication area 80, there is a possibility of handover to be performed immediately and a communication distance from the base station 31b is long, so that good communication quality cannot be expected, and therefore, the relay station candidate selection unit 64 selects, for example, a neighboring vehicle present at a position close to the center of the communication area 80 as the candidate for the relay station.

Regarding the candidate for the relay station to be selected, the relay station candidate selection unit 64 may select not one candidate but a plurality of candidates for relay stations. In that case, the relay station candidate selection unit 64 performs prioritization on the basis of the positions of the plurality of relay stations and the like, and holds information on the candidates for relay stations in a list format in which a candidate for a relay station having a higher priority is placed closer to the top. Since the relay station candidate selection unit 64 knows the position information of the neighboring vehicles 21 to 25 connected to the base station 31b, the relay station candidate selection unit 64 may estimate the traveling directions, the traveling routes, the traveling speeds, and the like of the neighboring vehicles 21 to 25 from a transition in the position information of the neighboring vehicles 21 to 25, and may select the candidate for the relay station in consideration of these pieces of estimated information. In addition, the relay station candidate selection unit 64 may select the candidate for the relay station by using road information such as an accident, congestion, and road closure regarding the road on which the neighboring vehicles 21 to 25 travel.

In a case where there is a request from the base station 30b as another base station, the communication control unit 61 performs control to provide the base station 30b as another base station with relay station candidate information which is information on the candidate for the relay station selected by the relay station candidate selection unit 64.

The base station 30b makes a request to the base station 31b for the relay station candidate information, and provides the vehicle 10 with the relay station candidate information acquired from the base station 31b.

In the in-vehicle terminal 11a of the vehicle 10, the V2N communication unit 43 receives the relay station candidate information provided from the base station 30b, and the connected terminal information holding unit 49 holds the relay station candidate information via the V2N communication control unit 44 similarly to the connected terminal information including the position information. The communication area calculation unit 50 acquires the relay station candidate information from the connected terminal information holding unit 49 and outputs the relay station candidate information to the relay station candidate selection unit 47. The relay station candidate selection unit 47 uses the neighboring vehicle information, the connected terminal information including the position information, the communication area 80, and the relay station candidate information to select the relay station from among candidates for the relay station indicated by the relay station candidate information. As described above, in the third embodiment, the relay management unit 46a holds the relay station candidate information which is information on the neighboring vehicles to be candidates for the relay station acquired from the base station 30b, and selects the relay station by further using the relay station candidate information. Note that regarding a method for acquiring the relay station candidate information, the redundant system management unit 45 of the in-vehicle terminal 11a of the vehicle 10 may make a request to the base station 30b, or similarly to the case of the connected terminal information, in a case where the base station 30b is to make a request to the base station 31b for the relay station candidate information when notified of the failure in connection to the base station 31b from the vehicle 10, the redundant system management unit 45 of the in-vehicle terminal 11a of the vehicle 10 only needs to notify the base station 30b of the failure in connection to the base station 31b.

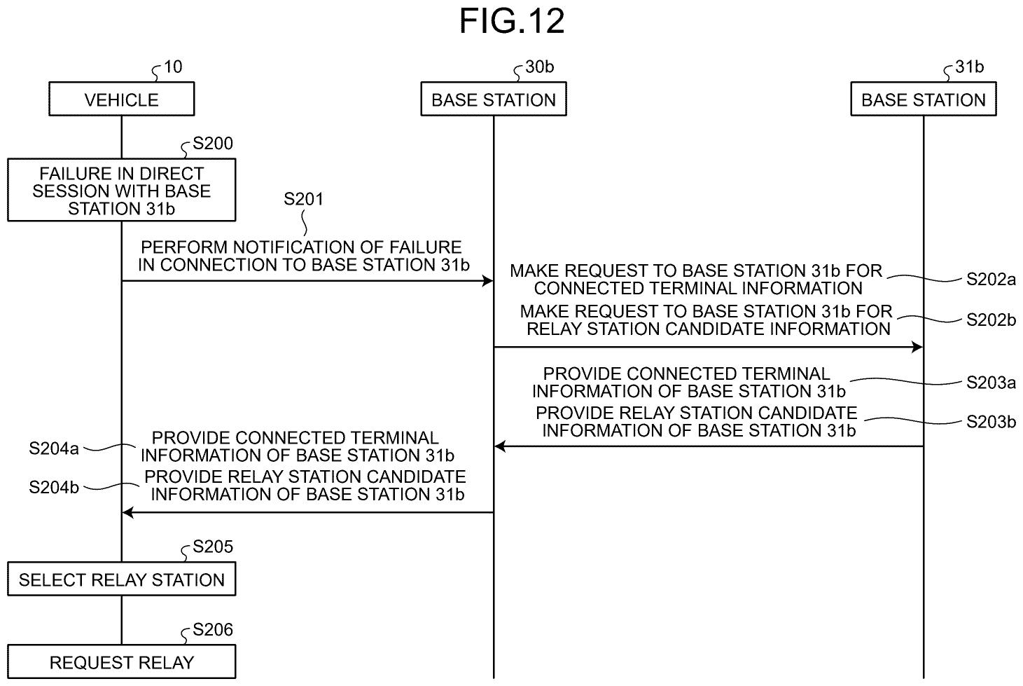

FIG. 12 is a sequence diagram illustrating an operation in which the vehicle 10 including the in-vehicle terminal 11a according to the third embodiment installed thereon acquires connected terminal information and relay station candidate information of the base station 31b via the base station 30b. When the direct session with the base station 31b fails (step S200), the vehicle 10 notifies the base station 30b of the failure in connection to the base station 31b (step S201). Here, assuming that the base station 30b is to make a request to the base station 31b for the connected terminal information and the relay station candidate information when notified of the failure in connection to the base station 31b from the vehicle 10 as described above, the vehicle 10 notifies the base station 30b of the failure in connection to the base station 31b only. When notified of the failure in connection to the base station 31b from the vehicle 10, the base station 30b makes a request to the base station 31b for connected terminal information which is information on neighboring vehicles connected to the base station 31b (step S202a), and makes a request to the base station 31b for relay station candidate information which is information on candidates for the relay station selected by the base station 31b (step S202b). The base station 31b provides the base station 30b with the connected terminal information which is information on the neighboring vehicles connected to the base station 31b (step S203a), and provides the base station 30b with the relay station candidate information which is information on the candidates for the relay station (step S203b). When the connected terminal information which is information on the neighboring vehicles connected to the base station 31b and the relay station candidate information which is information on the candidates for the relay station are provided from the base station 31b, the base station 30b provides the vehicle 10 with the connected terminal information which is information on the neighboring vehicles connected to the base station 31b (step S204a) and provides the vehicle 10 with the relay station candidate information which is information on the candidates for the relay station (step S204b). When acquiring, from the base station 30b, the connected terminal information which is information on the neighboring vehicles connected to the base station 31b and the relay station candidate information which is information on the candidates for the relay station, the vehicle 10 selects a candidate for the relay station to be used for an indirect session with the base station 31b on the basis of the neighboring vehicle information, the connected terminal information, and the relay station candidate information (step S205), and requests the selected relay station to relay to the base station 31b in the indirect session (step S206).

In a case of notifying the base station 30b of the failure in connection to the base station 31b in step S201, the in-vehicle terminal 11a of the vehicle 10 may notify the base station 30b of information such as position information, a traveling direction, a traveling speed, route information, and road information of the vehicle 10. In that case, the base station 30b also notifies the base station 31b of information such as the position information, the traveling direction, the traveling speed, the route information, and the road information of the vehicle 10 in step S202a or step S202b. Consequently, the base station 31b can select a candidate for the relay station in consideration of the position information, the traveling direction, the traveling speed, the route information, the road information, and the like of the vehicle 10. For example, the relay station candidate selection unit 64 of the base station 31b limits neighboring vehicles to neighboring vehicles present within a range of a distance in which V2X communication with the vehicle 10 may be able to be performed, and lists, from among the neighboring vehicles, neighboring vehicles less likely to perform handover immediately, neighboring vehicles having a relative speed close to that of the vehicle 10, neighboring vehicles expected to travel on the same road for a while, and the like, as candidates for the relay station having a higher priority.

Next, a hardware configuration of the base station will be described. In the base station, the relay station candidate selection unit 64 is realized by processing circuitry. The processing circuitry may be a processor that executes a program stored in a memory and the memory, or may be dedicated hardware.

As described above, according to the present embodiment, in a case of selecting a relay station to be used for establishing the indirect session, the in-vehicle terminal 11a installed on the vehicle 10 acquires the connected terminal information including the position information of the neighboring vehicles connected to the base station to which connection is desired and the relay station candidate information, via the base station with which the direct session is established, and selects the relay station by using the connected terminal information including the position information and the relay station candidate information. Consequently, in addition to the effects described in the first embodiment or the second embodiment, the in-vehicle terminal 11a can reduce a processing load when selecting the relay station.

### Fourth Embodiment

In the first to third embodiments, the in-vehicle terminal 11 or the in-vehicle terminal 11a of the vehicle 10 acquires the information on the neighboring vehicles connected to the base station as a target of the indirect session via the base station connected in the direct session. In a fourth embodiment, a case will be described where the in-vehicle terminal 11 or the in-vehicle terminal 11a of the vehicle 10 selects a relay station without receiving information provided from the base station. The fourth embodiment is applicable to the in-vehicle terminal 11 and the in-vehicle terminal 11a, but a description will be given below for the in-vehicle terminal 11 of the first embodiment, as an example.

In the vehicle 10, when the direct session with the base station 31 fails, the redundant system management unit 45 of the in-vehicle terminal 11 notifies the relay station candidate selection unit 47 of the failure. The relay station candidate selection unit 47 knows the neighboring vehicles 20 to 22 in V2X communication with the vehicle 10 on the basis of the neighboring vehicle information managed by the neighboring vehicle information management unit 42. The relay station candidate selection unit 47 makes a request, via the relay control unit 48, the V2X communication control unit 41, and the V2X communication unit 40, to the neighboring vehicles 20 to 22 connected via V2X communication for information on base stations to which the neighboring vehicles 20 to 22 are connected.

The neighboring vehicles 20 to 22 transmit, in V2X communication, information on the base stations to which the neighboring vehicles 20 to 22 are connected. Note that the neighboring vehicles 20 to 22 may transmit the information on the base stations to which the neighboring vehicles 20 to 22 are connected as independent information such as a base station list, or may transmit the information together with the position information of the neighboring vehicles 20 to 22 and the like at the time of V2X communication when the neighboring vehicle information management unit 42 of the vehicle 10 manages the information on the neighboring vehicles 20 to 22 as the neighboring vehicle information.

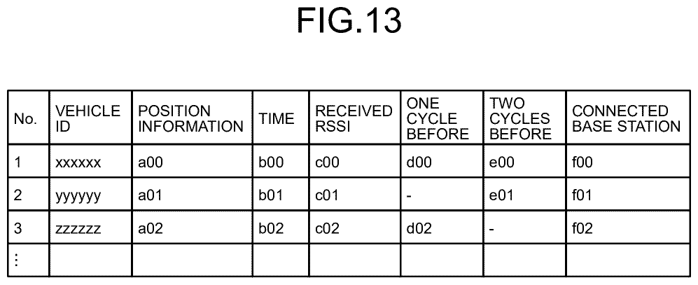

FIG. 13 is a diagram illustrating an example of neighboring vehicle information managed by the neighboring vehicle information management unit 42 of the in-vehicle terminal 11 according to the fourth embodiment. The neighboring vehicle information illustrated in FIG. 13 illustrates an example of a case where the neighboring vehicle information management unit 42 of the in-vehicle terminal 11 of the vehicle 10 manages information on the base stations connected to the neighboring vehicles 20 to 22 as the neighboring vehicle information. The neighboring vehicle information illustrated in FIG. 13 is obtained by adding information on connected base stations to the neighboring vehicle information of the first embodiment illustrated in FIG. 3. The number of connected base stations that are base stations connected to each neighboring vehicle is not limited to one, and may be two or more. Note that the neighboring vehicle information management unit 42 may manage information on the base stations connected to the neighboring vehicles 20 to 22 in the form of a base station list transmitted from the neighboring vehicles 20 to 22.

The relay station candidate selection unit 47 selects, as a relay station, a neighboring vehicle connected to a base station other than the base station 30 to which the vehicle 10 is connected, for example, the base station 31, on the basis of the neighboring vehicle information illustrated in FIG. 13 or the base station list managed by the neighboring vehicle information management unit 42.

In a case where the fourth embodiment is applied to the second embodiment or the third embodiment, in the in-vehicle terminal 11a installed on the vehicle 10, the communication area calculation unit 50 can calculate an approximate communication area of each base station included in the neighboring vehicle information illustrated in FIG. 13 or the base station list from the position information of each neighboring vehicle on the basis of the neighboring vehicle information illustrated in FIG. 13 or the base station list managed by the neighboring vehicle information management unit 42. In that case, the relay station candidate selection unit 47 can select a base station considered to be optimum as a relay station from the position information of the vehicle 10 and the like by further using the communication areas calculated by the communication area calculation unit 50 to select a relay station.

As described above, in the present embodiment, the neighboring vehicle information management unit 42 of the in-vehicle terminal 11 or the in-vehicle terminal 11a manages the neighboring vehicle information including the position information of the neighboring vehicles 20 to 22, the information on the communication state of the V2X communication, and the information on the base stations to which the neighboring vehicles 20 to 22 are connected, each of which having been acquired by the V2X communication, and the relay management unit 46 or the relay management unit 46a selects a relay station which is a neighboring vehicle that relays the indirect session with the base station that cannot be connected via the direct session, on the basis of the neighboring vehicle information. Consequently, the in-vehicle terminal 11 or the in-vehicle terminal 11a no longer needs to collect information via the base station, so that even in a case where a direct session with the base station cannot be established, it is possible to obtain information on relay stations to be candidates when selecting the relay station.

For example, the in-vehicle terminal 11 may perform the operation of the first embodiment in a case where at least one direct session has been established, and may perform the operation of the fourth embodiment in a situation in which no direct session has been able to be established. Similarly, the in-vehicle terminal 11a may perform the operation of the second embodiment or the third embodiment in a case where at least one direct session has been established, and may perform the operation of the fourth embodiment in a situation in which no direct session has been able to be established.

The in-vehicle terminal according to the present disclosure achieves an effect that it is possible to improve accuracy of selecting another in-vehicle terminal capable of relaying communication with a base station.

The configurations described in the above embodiments are merely examples and can be combined with other known technology, the embodiments can be combined with each other, and part of the configurations can be omitted or modified without departing from the gist thereof.

What is claimed is:

1. An in-vehicle terminal that is installed on a vehicle and performs wireless communication with a plurality of base stations through a plurality of paths, the in-vehicle terminal comprising:
vehicle-to-vehicle communication control circuitry to control communication with a neighboring vehicle present around the vehicle and capable of vehicle-to-vehicle communication;
neighboring vehicle information management circuitry to manage neighboring vehicle information including position information of the neighboring vehicle and information on a communication state of the vehicle-to-vehicle communication, acquired by the vehicle-to-vehicle communication;
base station communication control circuitry to perform control to provide a first base station that is the base station connected via direct communication with information on a second base station that is the base station unable to be connected via direct communication and to request the first base station to provide connected terminal information that is information on the neighboring vehicle connected to the second base station;
relay management circuitry to hold the connected terminal information acquired from the first base station, and to select a relay station that is the neighboring vehicle that relays indirect communication with the second base station on a basis of the neighboring vehicle information and the connected terminal information; and
redundant system management circuitry to manage connection to the first base station and the second base station, and to instruct the relay management circuitry to perform indirect communication with the second base station when the second base station is unable to be connected via direct communication.

2. The in-vehicle terminal according to claim 1, wherein
the neighboring vehicle includes a roadside device installed on a roadside of a road on which the vehicle travels.

3. The in-vehicle terminal according to claim 1, wherein
the connected terminal information includes position information of the neighboring vehicle connected to the second base station, and
the relay management circuitry calculates a communication area of the second base station on a basis of the connected terminal information, and selects the relay station by further using the communication area of the second base station.

4. The in-vehicle terminal according to claim 3, wherein
the relay management circuitry estimates a relayable time that is a time until the neighboring vehicle leaves the communication area of the second base station, and selects the relay station by further using the relayable time.

5. The in-vehicle terminal according to claim 3, wherein
when the vehicle reaches the communication area of the second base station, the redundant system management circuitry controls the base station communication control circuitry to attempt direct communication with the second base station.

6. The in-vehicle terminal according to claim 1, wherein
the relay management circuitry holds relay station candidate information that is information on the neighboring vehicle to be a candidate for the relay station acquired from the first base station, and selects the relay station by further using the relay station candidate information.

7. The in-vehicle terminal according to claim 1, wherein
the neighboring vehicle information management circuitry manages the neighboring vehicle information including position information of the neighboring vehicle, information on a communication state of the vehicle-to-vehicle communication, and information on the second base station to which the neighboring vehicle is connected, acquired by the vehicle-to-vehicle communication, and
the relay management circuitry selects, on a basis of the neighboring vehicle information, the relay station that relays an indirect connection to the second base station unable to be connected via a direct connection.

8. A base station in a wireless communication system in which a vehicle including an in-vehicle terminal installed thereon performs wireless communication with a plurality of base stations through a plurality of paths, the base station comprising:
connected terminal information acquisition circuitry to acquire identification information of the vehicle with which the wireless communication is performed and hold the identification information as connected terminal information;
communication control circuitry to control wireless communication with the vehicle and communication with another base station, and to perform control to provide the another base station with the connected terminal information in a case where there is a request from the another base station;
terminal position information acquisition circuitry to acquire and hold position information of the vehicle with which the wireless communication is performed; and
relay station candidate selection circuitry to select, on a basis of the connected terminal information including position information of a first vehicle that is the vehicle, the first vehicle to be a candidate for a relay station to be used by a second vehicle at a time of indirect communication with the base station, the second vehicle being directly connected to the another base station by wireless communication, wherein
in a case where there is a request from the another base station, the communication control circuitry performs control to include position information of the vehicle in the connected terminal information and provide the another base station with the connected terminal information and performs control to provide the another base station with information on the candidate for the relay station.

9. A wireless communication system comprising:
the in-vehicle terminal according to claim 1; and
the base station in a wireless communication system in which a vehicle including an in-vehicle terminal installed thereon performs wireless communication with a plurality of base stations through a plurality of paths, the base station comprising: connected terminal information acquisition circuitry to acquire identification information of the vehicle with which the wireless communication is performed and hold the identification information as connected terminal information; and communication control circuitry to control wireless communication with the vehicle and communication with another base station, and to perform control to provide the another base station with the connected terminal information in a case where there is a request from the another base station.

10. A relay station selection method performed by an in-vehicle terminal that is installed on a vehicle and performs wireless communication with a plurality of base stations through a plurality of paths, the relay station selection method comprising:
controlling communication with a neighboring vehicle present around the vehicle and capable of vehicle-to-vehicle communication;
managing neighboring vehicle information including position information of the neighboring vehicle and information on a communication state of the vehicle-to-vehicle communication, acquired by the vehicle-to-vehicle communication;
performing control to provide a first base station that is the base station connected via direct communication with information on a second base station that is the base station unable to be connected via direct communication and to request the first base station to provide connected terminal information that is information on the neighboring vehicle connected to the second base station;
holding the connected terminal information acquired from the first base station, and selecting a relay station that is the neighboring vehicle that relays indirect communication with the second base station on a basis of the neighboring vehicle information and the connected terminal information; and
managing connection to the first base station and the second base station, and giving an instruction to perform indirect communication with the second base station when the second base station is unable to be connected via direct communication.
